(19) United States
(12) Patent Application Publication
(10) Pub. No.: US 2017/0351955 A1
(43) Pub. Date: Dec. 7, 2017

(54) INTERMODAL DEMAND ESTIMATION TO TRANSIT ENTRY MONITORING

(71) Applicant: Cubic Corporation, San Diego, CA (US)

(72) Inventor: Graham Paul Fletcher, Stanford in the Vale (GB)

(73) Assignee: Cubic Corporation, San Diego, CA (US)

(21) Appl. No.: 15/615,488

(22) Filed: Jun. 6, 2017

Related U.S. Application Data
(60) Provisional application No. 62/346,909, filed on Jun. 7, 2016.

(51) Int. Cl. G06N 5/02

(52) U.S. Cl. CPC G06N 5/022; G06Q 2240/00

(57) ABSTRACT

A passenger's activity at the normal entry and exit points to the transit system may be recorded and linked, using a transit ticking system, along with the passenger's transit time and onward travel mode (bike hire, taxi, etc.). These records can be linked to other parameters such as the time, day of the week, season of the year, weather, and/or other such parameters. Furthermore, the passenger may use the transit ticketing system to make onward travel reservations such a bike hire or taxi. Such reservations will also be linked with the entry and exit and other parameters. The passenger's entry and exit on subsequent visits may be recorded and aggregated with past travel parameters. Thus, when a user enters the transit system, the records for that user can be used to predict how long they may be in transit, where they may exit the transit system, and what type of onward travel they may use.

### CROSS-REFERENCES TO RELATED APPLICATIONS

This application is a nonprovisional of and claims the benefit of priority to U.S. Provisional Patent Application No. 62/346,909, filed Jun. 7, 2016, entitled “INTERMODAL DEMAND ESTIMATION TO TRANSIT ENTRY MONITORING,” the entire content of which is herein incorporated in its entirety.

### BACKGROUND OF THE INVENTION

Estimating the demand for last mile transport for passengers arriving at a metro station is difficult. For example, estimating the right number of taxis or other transportation when train or bus passengers arrive at a metro station can be a challenge. And, if not done correctly, waiting onward passengers congest the metro station and they may not arrive at their endpoint destination on time due to lack of taxis and other transportation available to deliver them. Traditional prediction models are based on statistical analysis of transit exits. These models are built on an analysis of historical data recorded at the exit of a metro station such as the number of people exiting the station at 7:48 am is 213. These models are not linked to the travel of a specific passenger.

### BRIEF SUMMARY OF THE INVENTION

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a processor-based method for forecasting onward-travel demand in a transit system, the method including: continuously receiving, over a network and at a transit server, one or more user records from an onward-travel server, where each user record of the one or more user records includes a departure time from one of a plurality of departure locations; an arrival time of one or more arrival times, to one of one or more arrival locations; and an onward-travel type of one or more onward-travel types; The method also includes processing, by the transit server, the one or more user records, for each arrival location of one or more arrival locations, and for each arrival time of one or more arrival times at each location, and for each onward-travel type of one or more travel types at each location at each arrival time, the processing including determining an onward-travel count of one or more onward-travel counts for one or more users, where the one or more users need an onward-travel type; generating a request of one or more requests, for an onward-travel count of the onward-travel type; and transmitting, over the network, the request of the one or more requests to an onward transportation resource. Other embodiments of this aspect include corresponding computer systems, apparatus, and computer programs recorded on one or more computer storage devices, each configured to perform the actions of the methods.

Implementations may include one or more of the following features. The processor-based method for forecasting onward-travel demand in a transit system where the one or more onward-travel types include one or more of ride shares, taxis, bicycle hires, pedal-cabs, limousines, buses, shuttles, personal drones, and hover-craft. The processor-based method for forecasting onward-travel demand in a transit system where the transit system includes one or more of trains, light-rail, subway, busses, ferries, and/or airplanes. The processor-based method for forecasting onward-travel demand in a transit system the method further including: reading, by a fare-reader, a fare media at a read time and at a user departure location, where the user departure location is a one of the one or more departure locations, where the fare media is associated with a user identification of a user; transmitting, by the fare-reader and over the network, to the onward-travel server: the user identification; the read time; and the user departure location. The method may also include determining, by the onward-travel server, the user identification is associated with an onward-travel record in an onward-travel database. The method may also include retrieving, by the onward-travel server, the onward-travel record from the onward-travel database. The method may also include: determining, by the onward-travel server and from the onward-travel record, a user onward-travel type, where the user onward-travel type is one of the one or more onward-travel types, and a user arrival location, where the user arrival location is a one of the one or more arrival locations; generating, by the onward-travel server, a user arrival time, where the user arrival time is a one or the one or more arrival times, based on determining, by the onward-travel server, a next transport departure time at the user departure location; and determining, by the onward-travel server, a next transport arrival time at the user arrival location. The method may also include creating, by the onward-travel server, a user record of one or user records including a user departure time; the user departure location; the user arrival location; the user arrival time; and the user onward-travel type. The method may also include transmitting, by the onward-travel server, the user record of the one or more user records to the transit server. The processor-based method for forecasting onward-travel demand in a transit system the method further including creating the onward-travel record by recording one or more transactions of the user for a same arrival location at a same arrival time and using a same onward-travel type. The processor-based method for forecasting onward-travel demand in a transit system the method further including: reading, by a fare-reader, a fare media at a user departure location and at a read time, where the user departure location is a one of the one or more departure locations. The method may also include receiving a first input from a user of the one or more users, where the first input includes an user arrival location, where the user arrival location is a one of the one or more arrival locations. The method may also include receiving a second input from the user of the one or more users, where the second input includes a user onward-travel type, where the user onward-travel type is a one of the one or more onward-travel types. The method may also include transmitting, over the network and to the onward-travel server, the user departure location, the read time, the user arrival location, and the user onward-travel type; generating, by the onward-travel server, a user arrival time, where the user arrival time is a one of the one or more arrival times, based on: determining, by the onward-travel server, a next transport departure time at the user departure location; and determining a next transport arrival time at a user arrival location. The method may include creating, by the onward-travel server, a user record of one or more user records including the user departure location; the read time; the user arrival time; the user arrival location; and the user onward-travel type. The method may also include transmitting, over the network, the user record of the one or more user records to the transit server. Another embodiment includes a processor-based method for forecasting onward-travel demand in a transit system where the first input and the second input is provided in response to a request from a transit input device or from a user device of the user. Implementations of the described techniques may include hardware, a method or process, or computer software on a computer-accessible medium.

A second general aspect includes a non-transitory computer-readable medium having sets of instructions stored thereon for forecasting onward-travel demand in a transit system which, when executed by a computer, cause the computer to perform actions including: continuously receiving, over a network and at a transit server, one or more user records from an onward-travel server, where each user record of the one or more user records includes a departure time from one of a plurality of departure locations; an arrival time of one or more arrival times, to one of one or more arrival locations; and an onward-travel type of one or more onward-travel types; The actions also include processing, by the transit server, the one or more user records, for each arrival location of one or more arrival locations, and for each arrival time of one or more arrival times at each location, and for each onward-travel type of one or more travel types at each location at each arrival time, the processing including determining an onward-travel count of one or more onward-travel counts for one or more users, where the one or more users need an onward-travel type; generating a request of one or more requests, for an onward-travel count of the onward-travel type; and transmitting, over the network, the request of the one or more requests to an onward transportation resource. Other embodiments of this aspect include corresponding computer systems, apparatus, and computer programs recorded on one or more computer storage devices, each configured to perform the actions of the methods.

Implementations may include one or more of the following features. A non-transitory computer-readable medium having sets of instructions stored thereon for forecasting onward-travel demand in a transit system which, when executed by a computer, cause the computer to perform actions including where the one or more onward-travel types include one or more of ride shares, taxis, bicycle hires, pedal-cabs, limousines, buses, shuttles, personal drones, and hover-craft. The non-transitory computer-readable medium having sets of instructions stored thereon for forecasting onward-travel demand in a transit system where the transit system includes one or more of trains, light-rail, subway, busses, ferries, and/or airplanes. The non-transitory computer-readable medium having sets of instructions stored thereon for forecasting onward-travel demand in a transit system further including: reading, by a fare-reader, a fare media at a read time and at a user departure location, where the user departure location is a one of the one or more departure locations, where the fare media is associated with a user identification of a user; transmitting, by the fare-reader and over the network, to the onward-travel server: the user identification; the read time; and the user departure location. The actions may also include determining, by the onward-travel server, the user identification is associated with an onward-travel record in an onward-travel database. The action may also include retrieving, by the onward-travel server, the onward-travel record from the onward-travel database. The actions may also include: determining, by the onward-travel server and from the onward-travel record, a user onward-travel type, where the user onward-travel type is one of the one or more onward-travel types, and a user arrival location, where the user arrival location is a one of the one or more arrival locations; generating, by the onward-travel server, a user arrival time, where the user arrival time is a one or the one or more arrival times, based on determining, by the onward-travel server, a next transport departure time at the user departure location; and determining, by the onward-travel server, a next transport arrival time at the user arrival location. The actions may also include creating, by the onward-travel server, a user record of one or user records including a user departure time; the user departure location; the user arrival location; the user arrival time; and the user onward-travel type. The actions may also include transmitting, by the onward-travel server, the user record of the one or more user records to the transit server. The non-transitory computer-readable medium having sets of instructions stored thereon for forecasting onward-travel demand in a transit system further including creating the onward-travel record by recording one or more transactions of the user for a same arrival location at a same arrival time and using a same onward-travel type. The non-transitory computer-readable medium having sets of instructions stored thereon for forecasting onward-travel demand in a transit system further including: reading, by a fare-reader, a fare media at a user departure location and at a read time, where the user departure location is a one of the one or more departure locations. The actions may also include receiving a first input from a user of the one or more users, where the first input includes an user arrival location, where the user arrival location is a one of the one or more arrival locations. The actions may also include receiving a second input from the user of the one or more users, where the second input includes a user onward-travel type, where the user onward-travel type is a one of the one or more onward-travel types. The actions may also include transmitting, over the network and to the onward-travel server, the user departure location, the read time, the user arrival location, and the user onward-travel type; generating, by the onward-travel server, a user arrival time, where the user arrival time is a one of the one or more arrival times, based on: determining, by the onward-travel server, a next transport departure time at the user departure location; and determining a next transport arrival time at a user arrival location. The actions may include creating, by the onward-travel server, a user record of one or more user records including the user departure location; the read time; the user arrival time; the user arrival location; and the user onward-travel type. The actions may also include transmitting, over the network, the user record of the one or more user records to the transit server. The non-transitory computer-readable medium having sets of instructions stored thereon for forecasting onward-travel demand in a transit system where the first input and the second input is provided in response to a request from a transit input device or from a user device of the user. Implementations of the described techniques may include hardware, a method or process, or computer software on a computer-accessible medium.

A third general aspect includes system for: continuously receiving, over a network and at a transit server, one or more user records from an onward-travel server, where each user record of the one or more user records includes a departure time from one of a plurality of departure locations; an arrival time of one or more arrival times, to one of one or more arrival locations; and an onward-travel type of one or more onward-travel types; The system also includes processing, by the transit server, the one or more user records, for each arrival location of one or more arrival locations, and for each arrival time of one or more arrival times at each location, and for each onward-travel type of one or more travel types at each location at each arrival time, the processing including determining an onward-travel count of one or more onward-travel counts for one or more users, where the one or more users need an onward-travel type; generating a request of one or more requests, for an onward-travel count of the onward-travel type; and transmitting, over the network, the request of the one or more requests to an onward transportation resource. Other embodiments of this aspect include corresponding computer systems, apparatus, and computer programs recorded on one or more computer storage devices, each configured to perform the system of the methods.

Implementations may include one or more of the following features. A system for forecasting onward-travel demand in a transit system which, when executed by a computer, cause the computer to perform system including where the one or more onward-travel types include one or more of ride shares, taxis, bicycle hires, pedal-cabs, limousines, buses, shuttles, personal drones, and hover-craft. The system for forecasting onward-travel demand in a transit system where the transit system includes one or more of trains, light-rail, subway, busses, ferries, and/or airplanes. The system further including: reading, by a fare-reader, a fare media at a read time and at a user departure location, where the user departure location is a one of the one or more departure locations, where the fare media is associated with a user identification of a user; transmitting, by the fare-reader and over the network, to the onward-travel server: the user identification; the read time; and the user departure location. The system may also include determining, by the onward-travel server, the user identification is associated with an onward-travel record in an onward-travel database. The system may also include retrieving, by the onward-travel server, the onward-travel record from the onward-travel database. The system may also include: determining, by the onward-travel server and from the onward-travel record, a user onward-travel type, where the user onward-travel type is one of the one or more onward-travel types, and a user arrival location, where the user arrival location is a one of the one or more arrival locations; generating, by the onward-travel server, a user arrival time, where the user arrival time is a one or the one or more arrival times, based on determining, by the onward-travel server, a next transport departure time at the user departure location; and determining, by the onward-travel server, a next transport arrival time at the user arrival location. The system may also include creating, by the onward-travel server, a user record of one or user records including a user departure time; the user departure location; the user arrival location; the user arrival time; and the user onward-travel type. The system may also include transmitting, by the onward-travel server, the user record of the one or more user records to the transit server. The non-transitory computer-readable medium having sets of instructions stored thereon for forecasting onward-travel demand in a transit system further including creating the onward-travel record by recording one or more transit system of the user for a same arrival location at a same arrival time and using a same onward-travel type. The non-transitory computer-readable medium having sets of instructions stored thereon for forecasting onward-travel demand in a transit system further including: reading, by a fare-reader, a fare media at a user departure location and at a read time, where the user departure location is a one of the one or more departure locations. The system may also include receiving a first input from a user of the one or more users, where the first input includes an user arrival location, where the user arrival location is a one of the one or more arrival locations. The system may also include receiving a second input from the user of the one or more users, where the second input includes a user onward-travel type, where the user onward-travel type is a one of the one or more onward-travel types. The system may also include transmitting, over the network and to the onward-travel server, the user departure location, the read time, the user arrival location, and the user onward-travel type; generating, by the onward-travel server, a user arrival time, where the user arrival time is a one of the one or more arrival times, based on: determining, by the onward-travel server, a next transport departure time at the user departure location; and determining a next transport arrival time at a user arrival location. The system may include creating, by the onward-travel server, a user record of one or more user records including the user departure location; the read time; the user arrival time; the user arrival location; and the user onward-travel type. The system may also include transmitting, over the network, the user record of the one or more user records to the transit server. The system for forecasting onward-travel demand in a transit system where the first input and the second input is provided in response to a request from a transit input device or from a user device of the user. Implementations of the described techniques may include hardware, a method or process, or computer software on a computer-accessible medium.

### BRIEF DESCRIPTION OF THE DRAWINGS

The present disclosure is described in conjunction with the appended figures:

FIG. 1 is a block diagram of an embodiment of a transit system.

FIG. 2 is a block diagram of an embodiment of a station system.

FIG. 3 is a perspective view of an embodiment of a transit vending machine.

FIG. 4 is a perspective view of an embodiment of a fare gate.

FIG. 5 is a schematic illustration of one embodiment of a fare gate.

FIG. 6 is a flowchart showing one embodiment of forecasting onward-travel.

FIG. 7 is a flowchart showing one embodiment of forecasting onward-travel with the aid of an onward-travel database.

FIG. 8 is a flowchart showing one embodiment of creating an onward-travel record.

FIG. 9 is a flowchart showing one embodiment of receiving user input to determine travel parameters.

FIG. 10 is a flowchart showing one embodiment of different user input methods.

FIG. 11 depicts a block diagram of an embodiment of a computer system.

FIG. 12 depicts a block diagram of an embodiment of a special-purpose computer system.

In the appended figures, similar components and/or features may have the same reference label. Where the reference label is used in the specification, the description is applicable to any one of the similar components having the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

In the following description, for the purposes of explanation, numerous specific details are set forth in order to provide a thorough understanding of various embodiments. It will be apparent, however, to one skilled in the art that various embodiments may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the disclosed systems and methods as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of invention(s) described herein increase the accuracy of predicting the demand and provide the prediction at a time (which may not be based on hour timeslots), and tie a significant proportion of the demand for onward transportation to specific passengers. Better predictions improve passenger experience because the passenger does not have to wait for onward transportation when the passenger arrives at the metro station.

A passenger's activity at the normal entry and exit points to the transit system may be recorded and linked, using a transit ticking system, along with the passenger's transit time and onward travel mode (bike hire, taxi, etc.). These records can be linked to other parameters such as the time, day of the week, season of the year, weather, and/or other such parameters. Furthermore, the passenger may use the transit ticketing system to make onward travel reservations such a bike hire or taxi. Such reservations will also be linked with the entry and exit and other parameters. The passenger's entry and exit on subsequent visits may be recorded and aggregated with past travel parameters. Thus, when a user enters the transit system, the records for that user can be used to predict how long they may be in transit, where they may exit the transit system, and what type of onward travel they may use.

This predicted demand for all passengers arriving at a particular metro station can then be aggregated for each destination metro station for all passengers arrive at that metro station in order to generate highly accurate demand forecasting for bike hire, taxis, and any other onward travel mode. Such demand forecasting can be relayed to the transit system or other system to provide the appropriate onward travel options for passengers arrive at metro stations. Transit systems can also use the highly accurate demand forecasting to offer new premium services for onward travel such as taxis, hire bikes or any other vehicle to be reserved for a specific passenger.

Advantages of such embodiments are that the system may react correctly to travel disruption. For example, if a passenger enters the system 15 minutes later than normal, their taxi may be requested 15 minutes later than normal. Other advantages may include: (1) that demand can be linked to specific passengers, enabling the reservation of high value “reserved taxis” and (2) increased accuracy in forecasting the number and types of onward transportation to make available at metro stations.

Other embodiments entail a transit system querying passengers (users) to provide onward travel plans via mobile phone devices or the like. For example, the transit system can send a message to the passenger to prompt the passenger to select a final destination and an onward travel mode. Furthermore, the transit system may ingest information from other sources to augment forecasting for onward travelers not arriving at the metro station on the transit system.

Although transit systems are described in the embodiments herein, other embodiments may be used in other applications where similar demand estimation may be beneficial. For instance, a venue system can forecast onward travel from a venue after a venue event. Or an education institute can forecast the onward travel needed for student passengers at the end of daily instruction. One of skill in the art can see that the inventive concepts discussed herein are widely applicable.

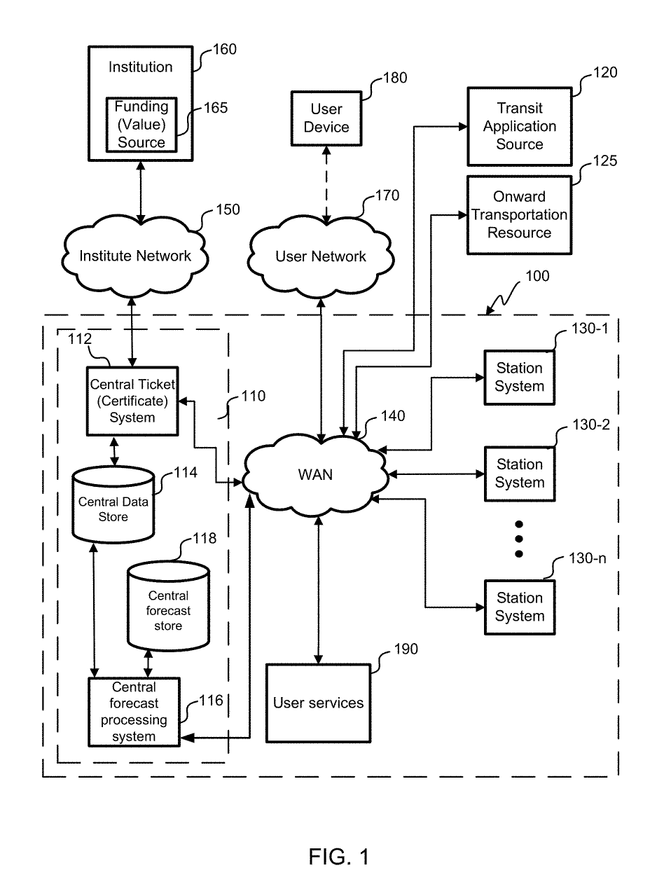

FIG. 1 illustrates a block diagram of an embodiment of a transit system 100, in communication with other systems. The transit system 100 can be used with any desired form of transit including, for example, subway, bus, ferry commuter rail, rail, para-transit, airplane, etc., or any combination thereof, and can be used to coordinate and/or control the operation of the other systems in providing services, including, transportation services.

The transit system 100 can include a central control system 110. The central control system 110 can include one or more servers and/or other computing systems having processors, memories, and network interfaces for processing and communicating information.

In the specific embodiment shown in FIG. 1, the central control system 110 can include a central certificate system 112. The central certificate system 112 can comprise one or more servers and/or other computing systems having processors, memories, and network interfaces for processing and communicating information. In some embodiments, the central certificate system 112 can be configured to provide information, receive information, and/or to track information relating to ticketing. In some embodiments, the central certificate system 112 can store information within a central data store 114. This information can include historical passenger information. It will be recognized that such a transit system 100 can be enabled for use in applications beyond transit, such as transportation systems (e.g., airline systems, car rental systems, etc.), building entry, and event entry.

In another embodiment shown in FIG. 1, the central control system 100 can include a central forecast processing system 116. One of skill in the art can recognize that central forecast processing system 116 could be included in certificate system 112. The central forecast processing system 116 can be connected to wide area network 140. Through wide area network 140 the central forecast processing system 116 can communicate with station systems 130. The central forecast processing system 116 can also be connected to central data store 114 so that it can share data with the certificate system 112. The central forecast processing system 116 can also be connected to a central forecast store 118. One of skill in the art can recognize that the central forecast store 118 could be included in the central data store 114. The central forecast store 118 may store system-wide forecasts that are sent to the station systems 130 in time periods that correspond to the learned time periods the passenger is predicted to pass through the station system 130.

The central forecast processing system 116 may use stored records from the central forecast store, real time passenger records from station systems 130, and input from user devices 180 to forecast onward travel needs at any given time for every (local) station. Central forecast processing system 116 aggregates records from all of these sources for each passenger arriving at each station. The central forecast processing system 116 may process all or some of the records and inputs to determine the types and quantities of onward transportation needed at each station at any point in time. For instance, the central forecast processing system 116 may determine that of 34 passengers arriving at station A at 7:45 am, 7 need a ride sharing car, 4 need a taxi, 12 need a bicycle share, and the remainder walk to their final destination. The central forecast processing system may transmit this information to the onward transportation resource 125.

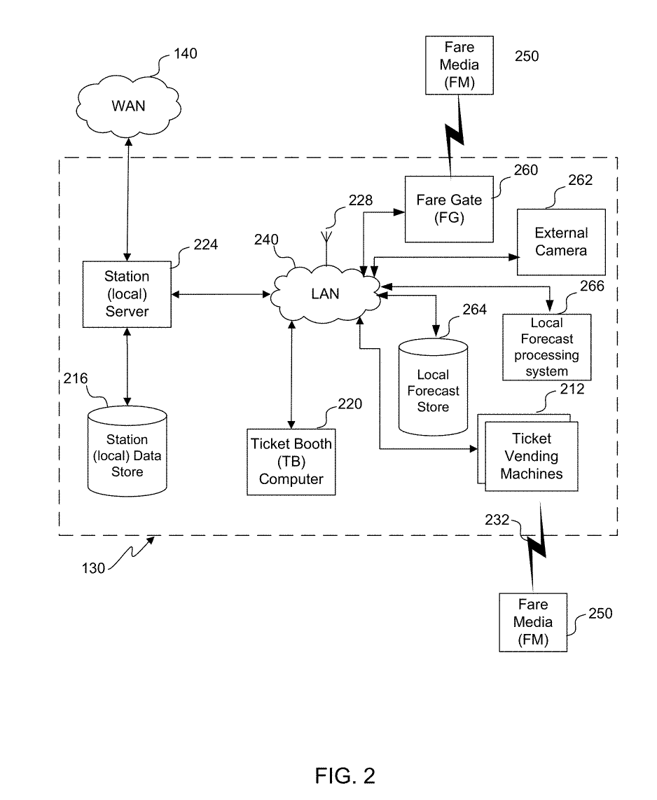

The central forecast processing system 116 may generate onward travel forecasts in various ways. First—an account holder may enter predicted times when the holder will be at a station, destination, and onward travel needs when creating or updating their account either at a TV machine 212 shown in FIG. 2, with a user device 180, or a non-user device or other methods. Thus, the central forecast processing system 116 may know what destination and onward travel information to retrieve from the central forecast store 118 associated with the account holder to aggregate data to send to onward transportation resource 125 and when to send it.

In another embodiment the central forecast processing system 116 may learn when to send the destination and onward travel needs associated with an account holder to the onward transportation resource 125. The central forecast processing system 116 is notified when the account holder presents FM 250 (FIG. 2) to pass through a fare gate (FG) 260 at station system 130. Once the central forecast processing system 116 determines that the same FM 250 holder is presenting the FM 250 associated with the same account holder and at the same station system 130 at the same time for a predetermined number of occurrences—the central forecast processing system 116 has “learned” this information and may use it to generate the forecasts it sends to the onward transportation resource 125.

In yet another embodiment the central forecast processing system 116 may also receive a notification from station system 130 that a passenger purchased a fare media 25 from ticket vending machine 212 (see FIG. 2) with a particular destination. Furthermore, the fare media passenger may use the fare gate 260 or TVM 212 to indicate on onward travel choice. The local forecast processing system 266 can send the time of arrival and onward travel choice to the central forecast processing system 116 so that the central forecast processing system 116 can use the information to generate a better forecast for onward travel needs.

The transit system 100 can include one or several station systems 130. In some embodiments, the station system 130 can comprise one or several systems and/or devices located within the station and/or within a mobile environment, which systems and/or devices can be used for ticketing and/or access control. Station systems 130 can gather information regarding transactions and communicate the information to the central certificate system 112 using a wide area network 140. The wide area network 140 can include one or more networks, such as the internet, which one or more networks may be public, private, or a combination of both. The wide area network 140 can be packet-switched or circuit-switched connections using telephone lines, coaxial cable, optical fiber, wireless communication, satellite links, and/or other mechanisms for communication. Communication between the station systems 130 and the central control system 110 may be in real time or periodic. Thus, the usage of FM 250 throughout the transit system 100 can be tracked and associated with the corresponding biometric identifier of the FM 250 holder. In one embodiment biometric identifiers can be communicated from the central certificate system 112 to the station system 130 via the wide area network 140. In other embodiments, changes in schedules, ticket prices, and delay notifications can be communicated from the central certificate system 112 to the station systems 130 via the wide area network 140.

In some embodiments, the transit system 100 can include a user services 190 that can be maintained and/or provided by the transit service provider of the transit system 100. In some embodiments, the user services 190 can comprise a call center and/or any other source of user support and/or service. User services 190 can also link to other transit systems and private onward travel services to provide passengers onward travel choices such as ride share, bicycle hire, taxis, limousines, etc.

Onward transportation resource 125 receives aggregated data from central forecasting processing system 116 and further incorporates other data to forecast onward travel needs for a local station at a particular time. In addition to the data received from central forecast processing system 116—on ward transportation resource 125 may receive data from user services directly from passengers and data for onward transportation services passengers arriving at local stations on foot, by car, bicycle, skateboard, hoover board, jet pack, personal drone, or any other transport forms.

The passenger can be identifiable and/or identified by the transit system 100. In some embodiments, the passenger can have, for example, a user account. The user account can comprise information regarding a certain user of the transit system 100, such as a name, address, phone number, email address, user identification (such as a unique identifier of the user or other user ID), passcode (such as a password and/or personal identification number (PIN)), an identification code associated with a FM 250 used to identify a user and/or a transit user account (such as a primary account number (PAN)), information regarding user preferences and user opt-in or opt-out selections for various services, product(s) associated with the transit user account, a value and/or credit associated with the product(s), information regarding a value source for the transit user account, and more. In one embodiment user preferences may include onward transportation preferences as well as travel preferences such as daily, weekly, monthly, or other periodic commute patterns.

The user may request a user account and provide the information listed above by phone (such as a call to the user services 190 maintained and/or provided by the transit service provider of the transit system 100), on the Internet, at ticket booth, at a ticket vending machine, or by other means. The central certificate system 112 can use the information provided by the user to create the user account that can be stored and/or maintained on a database, such as the central data store 114 of the central control system 110.

In some embodiments, the transit system 100 can complete a transaction with the value source 165 via an institution 160. In some embodiments, this transaction can occur via institute network 150, and in some specific embodiments, the central certificate system 112 can communicate with an institute network 150 to complete a transaction with the value source 165

In some embodiments, transit system 100 can communicate with one or several users operating a user device 180. The user device 180 may be communicatively coupled with the central control system 110. Such a user device 180 may be a smart phone or other mobile phone (including a near-field-communication enabled mobile phone), a tablet personal computer (PC), a personal digital assistant (PDA), an e-book reader, wearable device or other device. In transit system 100, a communicative link from user device 180 to central certificate system 112 can be provided by a user network 170 in communication with wide area network 140. User device 180 can thereby communicate with the central certificate system 112 to access and/or manage information of a user account. Furthermore, the central certificate system 112 can send messages to the user device 180, providing transit, account, and/or other information to a user of the transit system 100 in possession of the user device 180. Such messages may be based on, among other things, opt-in or opt-out selections and/or other user preferences as stored in a user account. In some embodiments, the user network 170 can comprise any type of communications including Bluetooth, local area network, intranet, wired internet, wireless internet, mobile communication network including, for example, cellular network, radio network, and/or the like.

A user can use the user device 180 to download a transit application from a transit application source 120. The transit application source 120 may be an application store or website provided by a mobile carrier, the hardware and/or software provider of the user device 180, and/or the transit service provider. The transit application can be uploaded or otherwise provided to transit application source 120 by the transit service provider. According to some embodiments, the transit application can provide additional functionality to the user device 180, including enabling a near field communication (NFC)-enabled user device to be used as FM 250 and access control points of the transit system 100. According to yet another embodiment the transit application may enable a transit passenger using a user device 180 to select the form of onward transportation the passenger requires at destination local station. The transit application can also allow the user to input one or more biometric identifiers including a facial picture, thumb print, palm print or any other biometric identifier. A user can access and/or use the transit system 100 in a variety of ways. In some embodiments, for example, the user can access the transit system 100 via the user device 180 and/or via one or several of the station systems 130.

FIG. 2 shows a block diagram of an embodiment of a station system 130. In some embodiments, the station system 130 can control ticketing operations and/or other operations relating to and/or involving the transit system 100. In some embodiments, the station system 130 can be associated with a specific geographic location such as, for example, a train station, an airport, a subway station, a bus station, a dock, a harbor, a retail location and/or any other location, and in some embodiments, the station system 130 can be associated with a mode of transit such as, for example, a bus, train, taxi, a boat, ferry, an airplane, a lift, and/or any other mode of transit.

Because different forms of transit may require different functionality, various station systems 130 may have some or all of the components shown in the block diagram. The components of the station system 130 can be communicatively linked to each other so as to allow the sending and receiving of information between the components of the station transit system 130. In some embodiments, this link can comprise a wired and/or wireless network. In the embodiment shown in FIG. 2, the components of the station system 130 can be linked by a local area network 240. The local area network 240 10 couple the various systems together and can include point-to-point connections, packet switched connections, wireless connections, and/or other networking techniques.

The station transit system 130 can include a local server 224 that can be coupled to the wide area network 140 to allow communication with the central certificate system 112. Processing of local information can be performed on the local server 224. For example, fare information, schedule information, delay update information, and other transit related information can be processed at the local server 224 and communicated to the various other machines in the transit system 100.

A ticket booth (TB) computer 220, and ticket vending machines (TV machines) 212 can communicate with the central certificate system 112 through the station computer server 224 or directly with the central certificate system 112 through local area network 240 or wide area network 140 (e.g., the Internet).

The TV machines 212, and one or more TB computers 220, can communicate with the local server 224 via the local area network 204. This communication can be transmitted via a physical connection or wireless connection via one or more antennas 228. Transactions at access control points 208, TV machines 212, and one or more TB computers 220 can be communicated to the local server 224, stored at local data store 216, and/or transmitted to central ticketing system, which can update information in a transit user account accordingly. TV machines 212 or TB computers 220 can communicate a passenger identified preference for onward travel to the local forecast processing system 266, which in turn, can communicate the identified preference and all associated passenger information to central forecast processing system 116 and the local forecast store 264.

Fare Gate (FG) 260 also communicates with local area network 240 to the transit system 100 and can also communicate over the wide area network 140. The FG 260 uses either network to communicate with certificate system 112. FG 260 also communicates with Fare Media (FM) 250. FG 260 can transmit FM 250 information over the local area network to local forecast system 266 to associate FM 250 with any onward travel selected by the passenger at the FG 260. The local forecast processing system 266 communicates over the local area network 240 with local forecast store 264 to store and retrieve passenger forecast records downloaded to the local forecast store 264 over the local area network 240 from the central forecast processing system 118. One of skill in the art can recognize that local forecast processing system 266 can be included in the local server 224. Passenger forecast records in the local forecast store 264 may correspond to the predicted forward transit preferences associated with FM 250 and account holders at the station system 130. The downloaded forecast records can be used at the ticket booth computer 220, the ticket vending machines 212 or the fare gate 260 to query or verify a particular passengers choice of onward travel based on historical or self-identified preferences. One of skill in the art can recognize that local forecast store 264 can be included in local data store 216. External camera 262 communicates over local area network 240 and can transmit digital images corresponding with biometric identifiers to the local forecast processing system 266 and/or the central validation system 116.

Various portable and/or handheld media with a unique identifier can be used as FM 250, whether or not the media is issued by a transit services provider. Such media can include identification cards, payment cards, personal electronic devices, bar codes and items having bar codes, contactless devices, and more. Contactless devices can include media having a unique identification code readable by access control points though near field communication signals (e.g., radio frequency signals). By way of example, but not by limitation, such contactless devices can include devices comprising radio frequency identification tags and/or radio frequency identification-tagged items, contactless payment cards (including but not limited to credit cards, prepaid cards, debit cards, or other bank cards or contactless smart cards.), contactless identification cards and/or fobs, and near field communication-enabled user devices.

FM 250 can have multiple sources of information, which may be read automatically by certain systems and devices in the transit system 100, depending on desired functionality. For contactless devices, such sources can include an integrated circuit, memory, and/or contactless interface of the device. Additionally or alternatively, contactless devices and other forms of FM 250 can include a magnetic stripe, a bar code, and/or data imprinted and/or embossed on the device, which can serve as additional sources of information. Contactless and other sources of information can serve as repositories of account information related to, for example, a financial or user account associated with the FM 250 (which may not be associated with the transit system 100).

TV machines 212 may interact directly with a FM 250 through, for example, a contactless connection 232. Although communication of the contactless connection 232 may be two way, FM 250 may simply communicate an identification code to TV machine 212. This can be done, for example, to authenticate a contactless device for use as FM 250 in the transit system 100. A contactless device does not have to be issued by a transit service provider in order to be authenticated and used as FM 250 in the transit system, as long as the information communicated by the FM 250 to the TV machine 212 (and subsequently to access control points 208 for passage in the transit system 100) serves to uniquely identify the FM 250. Such an authentication process is provided in greater detail below.

All or part of the information communicated by the FM 250 can be used as an identification code to identify the transit FM 250. This identification code can comprise one or more fields of data including or based on information such as a name, a birth date, an identification number (such as a PAN), a social security number, a driver's license number, a media access control (MAC) address, an electronic serial number (ESN), an international mobile equipment identifier (IMEI), and more. Because the identification code is unique, it can be associated with a transit user account, and utilized by a user at a TV machine 212 to access and/or update information associated with the transit user account.

In some instances, an identification code may be assigned by a transit service provider and written to the FM 250, such as an near field communication-enabled user device 280. For example, a transit application running on a near field communication-enabled phone can generate or otherwise provide an identification code to be transmitted from the phone at access control points of the transit system 100. In other instances, if TV machine 212 is utilized to enable a user to create a transit user account, the TV machine 212 may also write an identification code to an unused portion of a memory of the FM 250, such as integrated circuit chip file space on a smart card or a near field communication component on the near field communication-enabled user device 280.

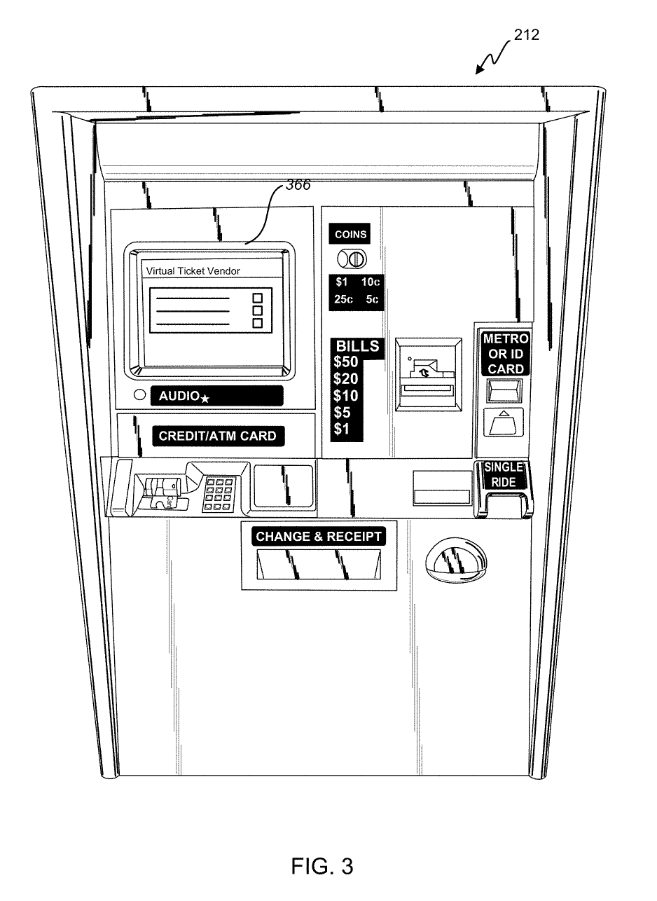

In FIG. 3 a perspective view of an embodiment of a TV machine 212 are shown. One of ordinary skill in the art will recognize the TV machines can vary in appearance and functionality. TV machines can be much smaller and comprise fewer functional components that are pictured here and can also comprise more functional components. The TV machine 212 can facilitate the vending of tickets and the completion and performance of a transaction between the user and the station system 130. The TV machine 212 can comprise a variety of shapes and sizes and can include any desired combination multiple components. Further explanation of the function of a TV machine 212 are discussed in detail in U.S. patent application Ser. No. 13/942,366 filed on Jul. 15, 2013 entitled “ON-BOARD ONWARDS TRAVEL ENABLEMENT KIOSK,” which is fully incorporated by reference herein. The TV machine 212 may contain a onward travel entry 366. The onward travel entry 366 may be a form of biometric identification reader including fingerprints, thumbprints, retina scans, palm prints, palm veins, or facial characteristic reader. The onward travel entry can be a digital imagery device, a scanning device, or any other form of onward travel entry. A FM 250 purchaser or account holder can pre-populate their onward travel preferences using the onward travel entry 366. When this happens—the process of onward travel forecasting becomes easier as for the account holder the preference is already known.

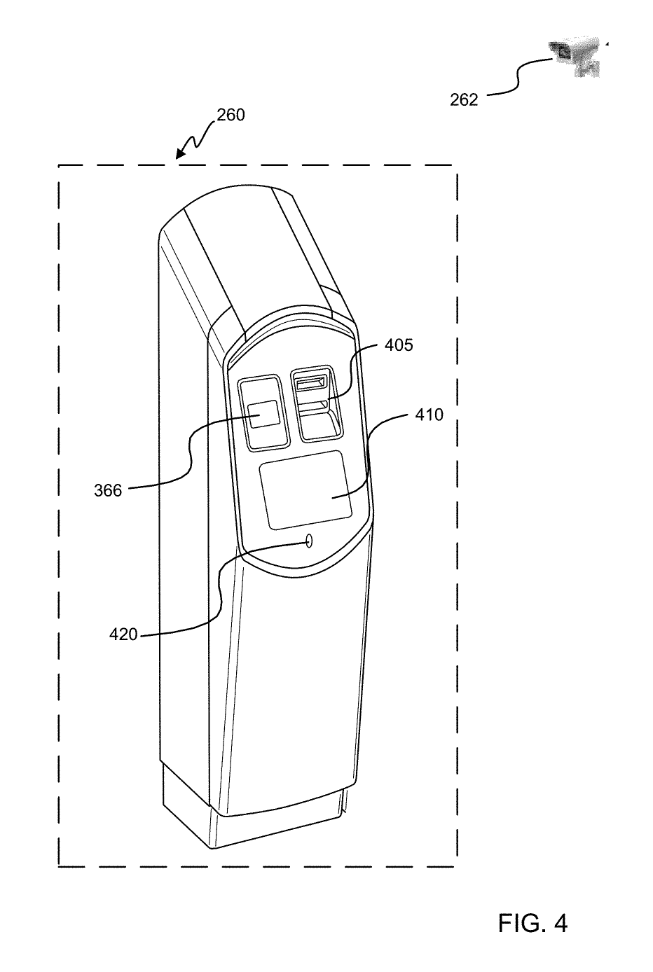

Referring now to FIG. 4 that depicts in more detail the FG 260 and the external camera 262 in one embodiment of the present invention. One of ordinary skill in the art will recognize that FG 260 can vary in appearance and functionality as can external camera 262. External camera 262 can capture and transmit a facial biometric identifier over the local area network 240. FG 260 can have an audio system 420. Audio system 420 can give verbal instructions on using any of the components of FG 260. For instance, in one embodiment audio system 420 can alert the FM 250 holder to enter a destination and onward travel preference at onward travel entry 366. FG 260 can contain a display system 410. For instance, in another embodiment, display system 410 can display a message for the FM 250 holder that asks the passenger to indicate an onward travel preference. In other embodiments the display system 410 can display any manner of other messages including instructions for using FG 260, instructions for using the transit system 100, and advertising. FG 260 can also comprise a FM 250 reader 405. FG 260 can also have a onward travel entry 366. FG 260 may also have a turnstile or other physical barrier associated with it that prevents entry until FM 250 is verified. One of ordinary skill in the art will recognize that onward travel entry 366 and display system 410 can be one and the same.

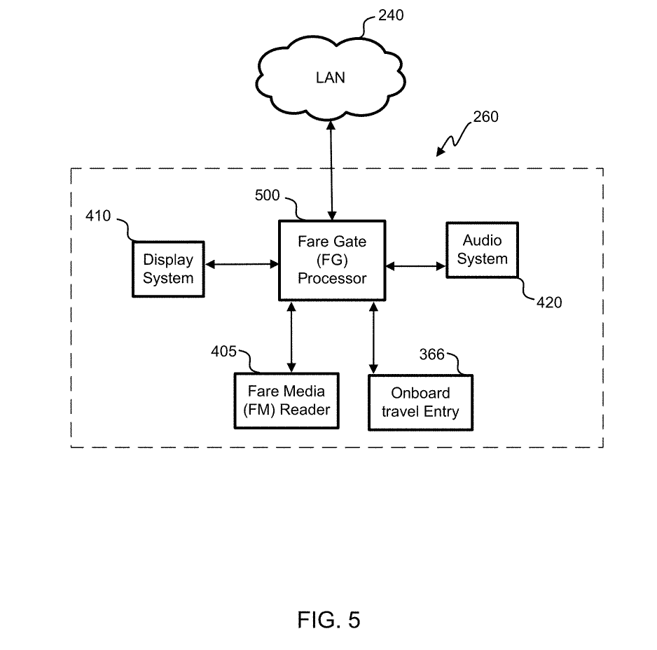

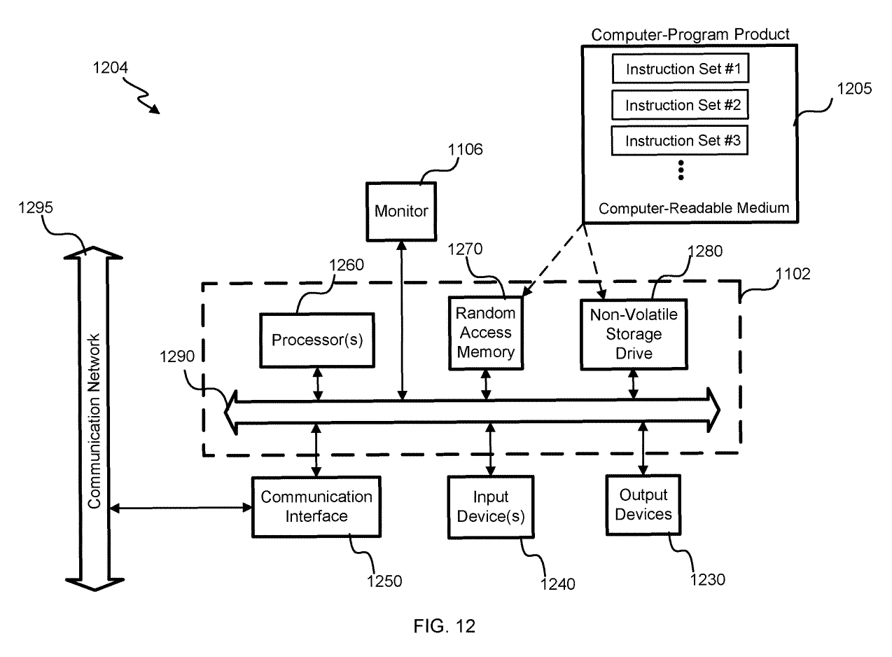

With reference now to FIG. 5 that depicts a block diagram of components of FG 260 in one embodiment of the present invention in communication with LAN 240. In this embodiment the FG processor 500, comprising a CPU or other type of hardware processing unit including associated memory, communication, and other components as described in FIG. 12 for user device 180, communicates with the local area network 240. The FG processor 500 can communicate with the display system 410 and provides the messaging presented on the display system 410. FG processor 500 can generate the messages to be displayed on the display system 410 or receive the message to be displayed from any number of sources over local area network 240. The FG processor 500 can communicate with the audio system 420. The FG processor 500 can generate the messages broadcast from the audio system 420 or receive the message to be broadcast from any number of sources over the local area network 240. The FG processor 500 can communicate with FM reader 405. The FG processor can determine if the FM 250 allows passage or can send the FM 250 information over the local area network 240 to make the determination. The FG processor can also communicate with the FM 250 in some embodiment directly or pass information and instructions from other sources connected to the local area network 240. The FG processor 500 also communicates with onward travel entry 366. The FG processor 500 passes onward travel preferences read by the onward travel entry 366 over the local area network to the local forecast processing system 266.

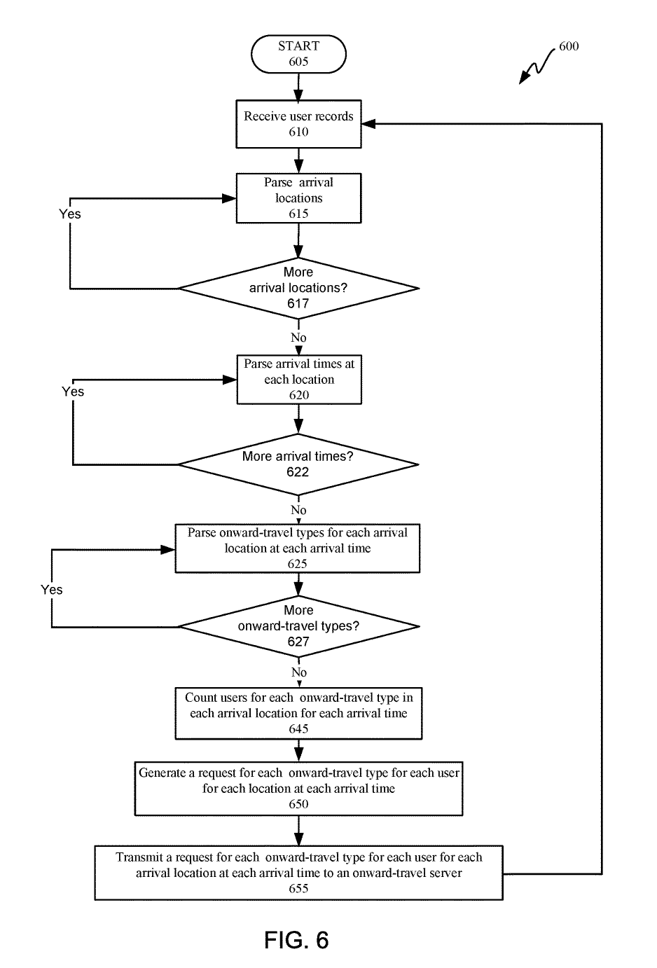

With reference now to FIG. 6, a flowchart 600 of one embodiment of onward-travel forecasting. Starting at 605 and then at 610 where a transit server, such as the central ticket system 112 or the central forecast processing system 116 receives one or more user records from on onward-travel server such as the central forecast processing system 116 or the local forecast processing system 266. One of skill in the art will recognize that the transit server and the onward-travel server can be all or a part of any processor or processing system in transit system 100 processor or processing system. Each user record comprises a user arrival location, a user arrival time, and an onward-travel type preference. The transit server my process many thousands of these records at any given time. At 615 the transit server parses the user records by arrival locations and may have many thousands of user records associated with each arrival location in the transit system. At 617 the transit server continues parsing at 615 or moves to 620 if there are no more arrival location. At 620 the transit server parses the user records for each arrival location by arrival times, and again, there may be thousands of user records for each arrival time at each arrival location. At 622 if there are more arrival times yet to parse, parsing is continued at 620. If all of the arrival times at each arrival location have been parsed, then at 625, the transit server parses the user records at each arrival location and for each arrival time by onward-travel type preference. At 627 if there are no more onward-travel types for each arrival time at each arrival locations, then at 645 the transit server counts the number of users for each onward-travel type at each arrival time at each arrival location. Then at 650 the transit server generates a request comprising the count for each onward-travel type for each arrival time for each arrival location. At 655 the request for each onward-travel type for each arrival time for each arrival location are transmitted to an onward-travel server. The onward travel server could be onward transportation resource 125. The onward travel server may be connected to other transportation entities such as ride share companies, taxi companies, pedal-cab companies, limousine services, etc.

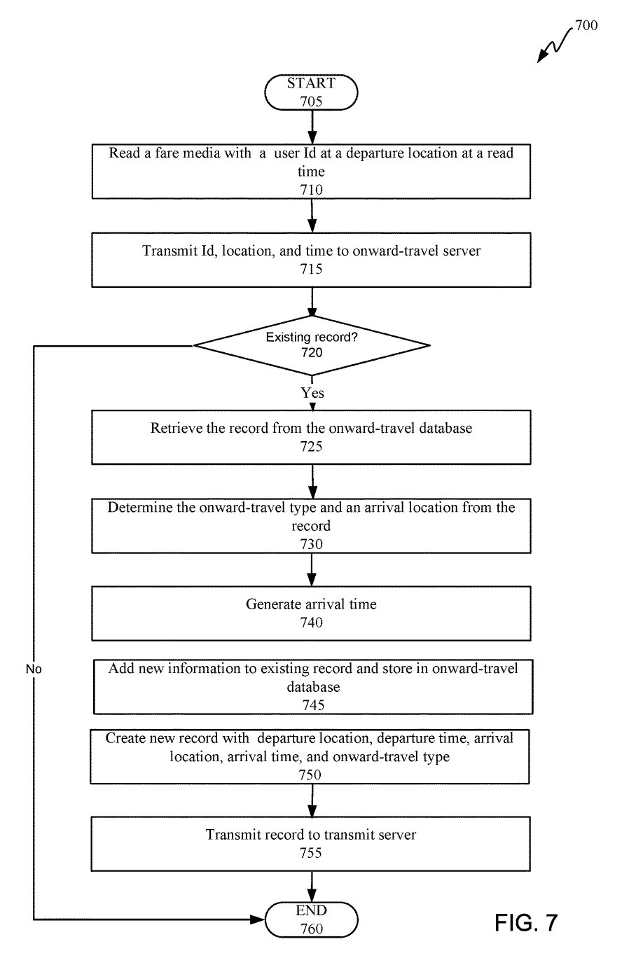

Referring now to FIG. 7, is a flowchart 700 is one embodiment of the present invention using an existing user record. Starting flowchart 700 at block 705 and moving to block 710 where a fare media reader (may be ticket vending machine 212, ticket booth computer 220, or fare gate 260) reads a fare media 250 and may determine a user ID, a user departure location and a read time. At 715 the user ID, user departure location, and the read time are transmitted to the onward-travel server. At 720 the transmit server determines if there is an existing onward-travel record matching the existing ID. If not the flowchart 700 ends at 760. If there is an existing record then at 725 the onward-travel record is retrieved from the onward-travel database. At 730 the onward-travel type and the arrival location is determined from the onward-travel record. At 740 the user arrival time at the arrival location is generated. This maybe done based on the knowledge of the travel times of the transit in question or any other manner of computing an arrival time. The new information is then added to the existing onward-travel record and the onward-travel record is stored at 745. A new user record is created at 750 that comprises the user departure location, departure time, arrival location, arrival time, and onward-travel type. The new user record is transmitted to the transmit server at 755 and flowchart 700 ends at 760.

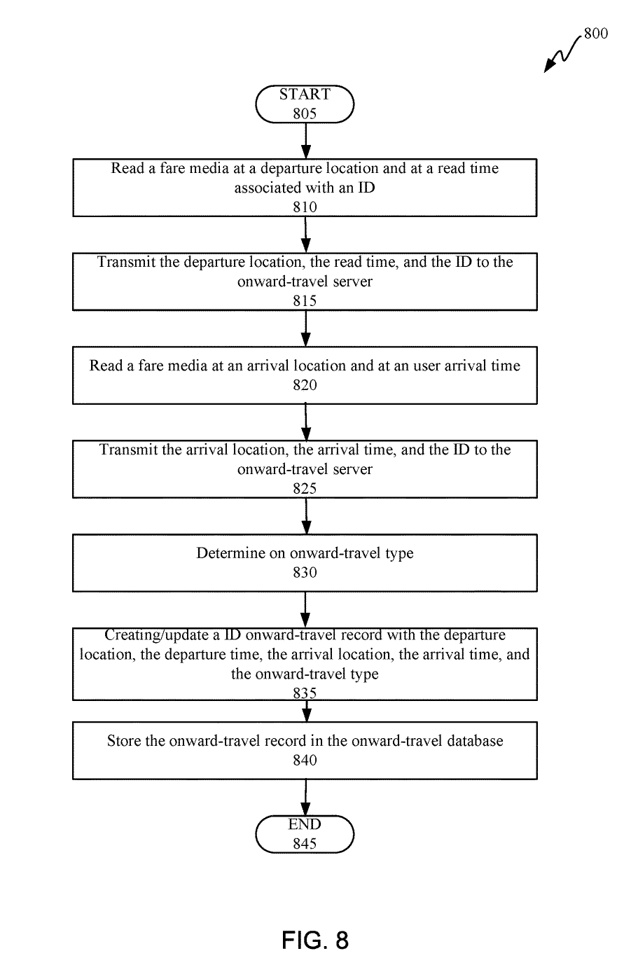

Referring now to FIG. 8 showing flowchart 805 of one embodiment of creating an onward-travel record for onward travel forecasting. Flowchart 800 starts at 805 and at 810 a fare gate 260, ticket vending machine 212, ticket booth 220 or other device reads fare media 250. The fare media identification, the departure location, and the read time are transmitted to the onward-travel server at 815. The fare media is read at the arrival location at 820 and at 825 the arrival location, arrival time, and the fare media ID is transmitted to the onward-travel server. At 830 the user's onward-travel type is determined. This determination can be made in many ways including the user using the transit system to schedule the onward-travel, the user entering in the onward-travel selection when purchasing a fare media 250, by a detection device such as a digital camera, or any other method for determining onward-travel. At 835 an onward-travel record is created corresponding to the fare media 250 ID if one does not already exist to comprise the fare media 250 ID, departure location, departure time, arrival location, arrival time, and the onward-travel type. The onward-travel record is stored for future use at 840. The flowchart reaches the end at 845.

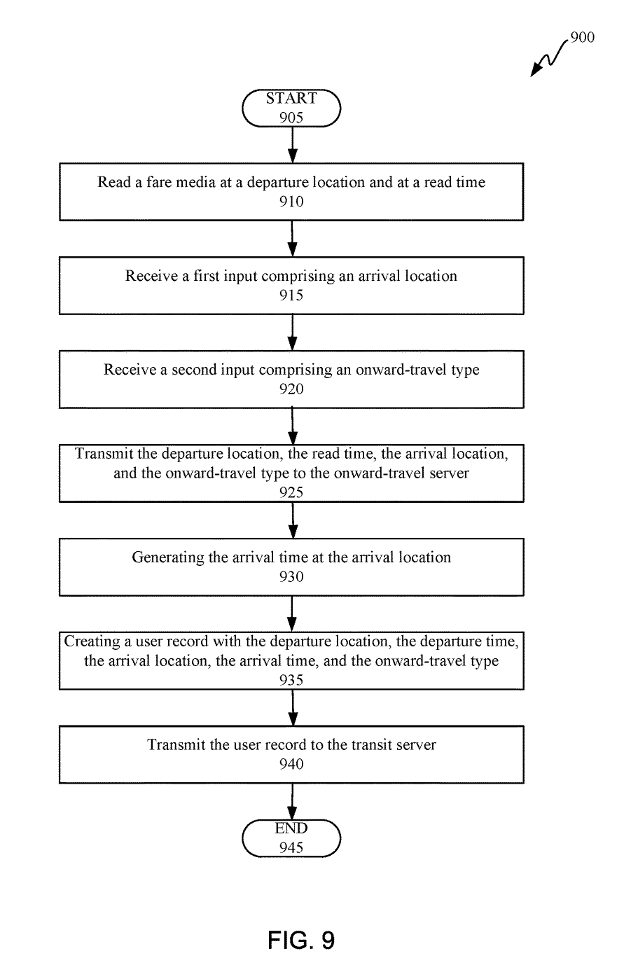

Referring now to FIG. 9 depicting flowchart 900 describing one embodiment of creating a user record using user input. Flowchart 900 starts at 905 and at 910 a fare gate 260 (or any other fare media 250 reader such as a ticket vending machine 212 or a ticket booth computer 220) reads a fare media 250 at a user departure location at a read time. At 915 a user input is received comprising an arrival location. At 920 a user input is received comprising an onward-travel type. At 925 the onward-travel type, the user departure location, the read time, and the arrival location are transmitted to the onward-travel server. The onward-travel server generates an arrival time as discussed in FIG. 7 at 740. The onward-travel server creates the user record comprising the departure location, the departure, time, the arrival location, the arrival time, and the onward-travel type. At 940 the user record is transmitted to the transit server. Flowchart 900 ends at 945.

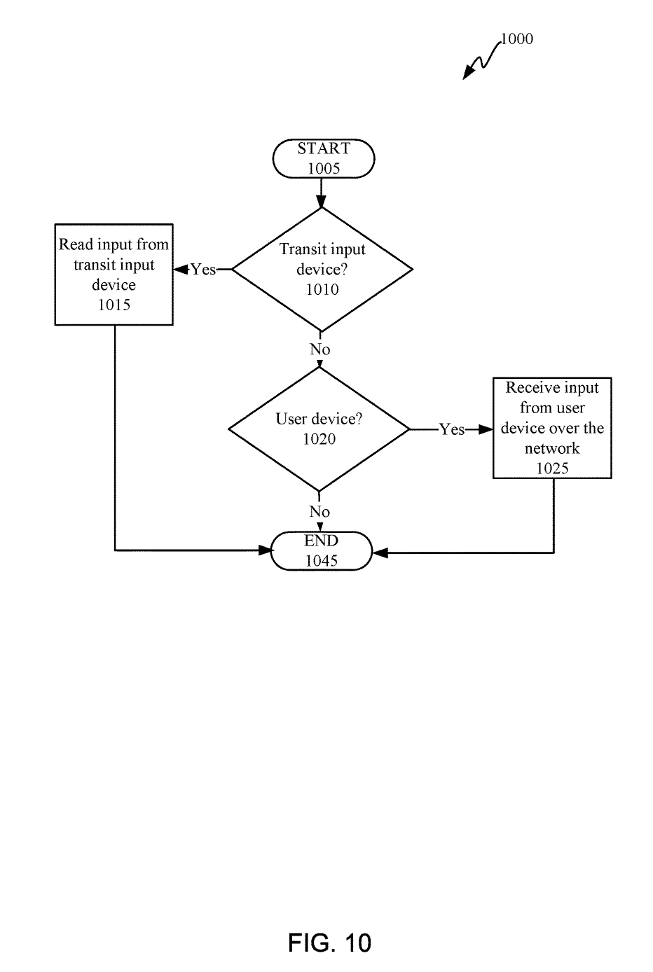

Looking now at FIG. 10 depicting flowchart 1000 describing one embodiment of user input in the present invention. The flowchart 1000 starts at 1005 and 1010 determines if the input is a transit input device such as at a fare gate 260, ticket vending machine 212, ticket booth 220, or any other input device in the transit system. The input type could be spoken, entered on keyboard or touch pad, touch selection on a touch screen—or any other input type. The flowchart would end at 1045. Returning to 1010, if the input device is not a transit input device, then if it is also not a user device used by the user the flowchart 1000 ends at 1045. If the input is a user device used by a user than at 1025 the user inputs on the user device. The user device may be connected by a wired or wireless network directly to the transit system or indirectly through an application or web page interface. The flowchart 1000 ends at 1045.

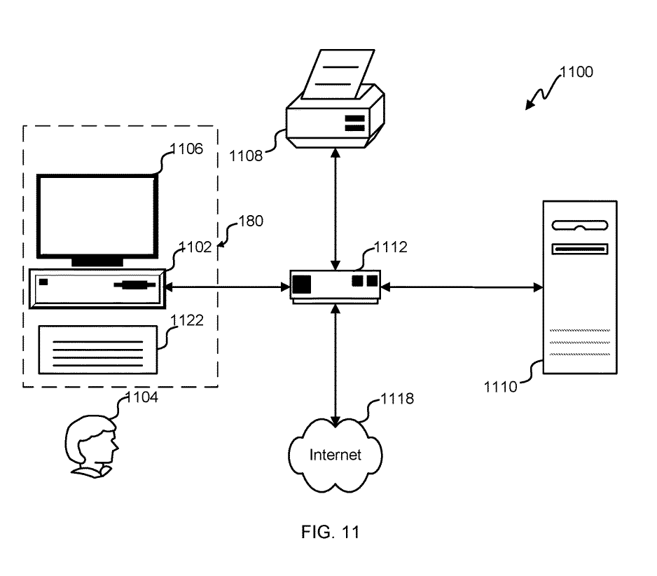

With reference now to FIG. 11, an exemplary environment with which embodiments may be implemented is shown with a user device 180 that can be used by a user 1104. The computer system 1100 can include a computer 1102, keyboard 1122, a network router 1112, a printer 1108, and a monitor 1106. The monitor 1106, processor 1102 and keyboard 1122 can be parts of user device 180, that may be a smart phone or other mobile phone (including a near-field-communication enabled mobile phone), a tablet personal computer (PC), a personal digital assistant (PDA), an e-book reader, wearable device, or other device. The monitor 1106 can be a CRT, flat screen, etc.

A user 1104 can input commands into the computer 1102 using various input devices, such as a mouse, keyboard 1122, track ball, touch screen, voice command, etc. If the computer system 1100 comprises a mainframe, a designer 1104 can access the computer 1102 using, for example, a terminal or terminal interface. Additionally, the user device 180 may be connected to a printer 1108 and a server 1110 using a network router 1112, which may connect to the Internet 1118 or a wide area network.

The server 1110 may, for example, be used to store additional software programs and data. In one embodiment, software implementing the systems and methods described herein can be stored on a storage medium in the server 1110. Thus, the software can be run from the storage medium in the server 1110. In another embodiment, software implementing the systems and methods described herein can be stored on a storage medium in the computer 1102. Thus, the software can be run from the storage medium in the user device 180. Therefore, in this embodiment, the software can be used whether or not computer 1102 is connected to network router 1112. Printer 1108 may be connected directly to computer 1102, in which case, the user device 180 can print whether or not it is connected to network router 1112.

With reference to FIG. 12, an embodiment of a special-purpose computer system 1204 is shown. The above methods may be implemented by computer-program products that direct a computer system to perform the actions of the above-described methods and components. Each such computer-program product may comprise sets of instructions (code) embodied on a computer-readable medium that directs the processor of a computer system to perform corresponding actions. The instructions may be configured to run in sequential order, or in parallel (such as under different processing threads), or in a combination thereof. After loading the computer-program products on the user device 180, it is transformed into the special-purpose computer system 1204.

Special-purpose computer system 1204 comprises a computer 1102, a monitor 1106 coupled to computer 1102, one or more additional user output devices 1230 (optional) coupled to computer 1102, one or more user input devices 1240 (e.g., keyboard, mouse, track ball, touch screen) coupled to computer 1102, an optional communications interface 1250 coupled to computer 1102, a computer-program product 1205 stored in a tangible computer-readable memory in computer 1102. Computer-program product 1205 directs system 1204 to perform the above-described methods. Computer 1102 may include one or more processors 1260 that communicate with a number of peripheral devices via a bus subsystem 1290. These peripheral devices may include user output device(s) 1230, user input device(s) 1240, communications interface 1250, and a storage subsystem, such as random access memory (RAM) 1270 and non-volatile storage drive 1280 (e.g., disk drive, optical drive, solid state drive), which are forms of tangible computer-readable memory.

Computer-program product 1205 may be stored in non-volatile storage drive 1280 or another computer-readable medium accessible to computer 1102 and loaded into memory 1270. Each processor 1260 may comprise a microprocessor, such as a microprocessor from Intel® or Advanced Micro Devices, Inc.®, or the like. To support computer-program product 1205, the computer 1102 runs an operating system that handles the communications of product 1205 with the above-noted components, as well as the communications between the above-noted components in support of the computer-program product 1205. Exemplary operating systems include Windows® or the like from Microsoft® Corporation, Solaris® from Oracle®, LINUX, UNIX, and the like.

User input devices 1240 include all possible types of devices and mechanisms to input information to computer system 1102. These may include a keyboard, a keypad, a mouse, a scanner, a digital drawing pad, a touch screen incorporated into the display, audio input devices such as voice recognition systems, microphones, and other types of input devices. In various embodiments, user input devices 1240 are typically embodied as a computer mouse, a trackball, a track pad, a joystick, wireless remote, a drawing tablet, a voice command system. User input devices 1240 typically allow a user to select objects, icons, text and the like that appear on the monitor 1106 via a command such as a click of a button or the like. User output devices 1230 include all possible types of devices and mechanisms to output information from computer 1102. These may include a display (e.g., monitor 1106), printers, non-visual displays such as audio output devices, etc.

Communications interface 1250 provides an interface to other communication networks 1295 and devices and may serve as an interface to receive data from and transmit data to other systems, wide area network s and/or the Internet 1118. Embodiments of communications interface 1250 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1250 may be coupled to a computer network, to a FireWire® bus, or the like. In other embodiments, communications interface 1250 may be physically integrated on the motherboard of computer 1102, and/or may be a software program, or the like.

RAM 1270 and non-volatile storage drive 1280 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1270 and non-volatile storage drive 1280 may be configured to store the basic programming and data constructs that provide the functionality of various embodiments of the present invention, as described above.

Software instruction sets that provide the functionality of the present invention may be stored in RAM 1270 and non-volatile storage drive 1280. These instruction sets or code may be executed by the processor(s) 1260. RAM 1270 and non-volatile storage drive 1280 may also provide a repository to store data and data structures used in accordance with the present invention. RAM 1270 and non-volatile storage drive 1280 may include a number of memories including a main random access memory (RAM) to store of instructions and data during program execution and a read-only memory (ROM) in which fixed instructions are stored. RAM 1270 and non-volatile storage drive 1280 may include a file storage subsystem providing persistent (non-volatile) storage of program and/or data files. RAM 1270 and non-volatile storage drive 1280 may also include removable storage systems, such as removable flash memory.

Bus subsystem 1290 provides a mechanism to allow the various components and subsystems of computer 1102 communicate with each other as intended. Although bus subsystem 1290 is shown schematically as a single bus, alternative embodiments of the bus subsystem may utilize multiple busses or communication paths within the computer 1102.

A number of variations and modifications of the disclosed embodiments can also be used. Specific details are given in the above description to provide a thorough understanding of the embodiments. However, it is understood that the embodiments may be practiced without these specific details. For example, well-known circuits, processes, algorithms, structures, and techniques may be shown without unnecessary detail in order to avoid obscuring the embodiments. It is also the case that modules, software, or algorithms can be performed on one server, multiple servers or share the same server. A platform is a major piece of software, such as an operating system, an operating environment, or a relational database or data store, under with various smaller application programs can be designed to run. An operating system is the most important software program running on most computer systems. It manages a processors memory, processes, all of the software and programs loaded onto it, and all of the connected hardware. The operating system's job is to manage all of the software and hardware on the computer. Most of the time, there are many different software programs operating at once as well as multiple connected hardware devices. There are many operating systems—the most basic is the disk operating system or “DOS.” Each type of computer or device typically has its own different operating systems. Some typical operating systems are iOS, Windows, Android, and Linux.

The networks disclosed may be implemented in any number of topologies. A network is made of many computing devices that can include computers, servers, mainframe computers, network devices, peripherals, or other devise connected together. A network allows these devices to share data and communicate with each other. The most prominent network is the Internet—that connects billions of devices all over the world. There are many types of network devices including: computers, consoles, firewalls, hubs, routers, smartphones, switches, wearables, watches, and cameras. Networks are set up in many different ways referred to as network topologies. Some of the most common topologies include tree, hybrid, ring, mesh star, and bus. The tree topology is the generally used topology. A computer is typically an electronic device for storing and processing data according to instruction it reads. A console is a text entry and display device. A firewall is network security system, either hardware- or software-based, that controls incoming and outgoing network traffic based on a set of rules, and acts as a barrier between a trusted network and other untrusted networks—such as the Internet—or less-trusted networks—a firewall controls access to the resources of a network through a positive control model. This means that the only traffic allowed onto the network defined in the firewall policy is; all other traffic is denied. A hub is a connection point for multiple devices in a network. A hub typically has multiple ports such that if packets of data arrive at one port they are copied to the other ports. A router is a device that forwards data packets along the network. A router connects two or more networks such as an intranet to the internet. Routers use headers and forwarding tables to determine how data packets should be sent using certain paths in the network. The typical router protocol using ICMP to communicate and configure the best path. A network switch is different from a router. Switches serve as controllers that enable networked devices to communicate with each other. Switches create networks while routers connect networks together.

Networks operate on the seven layer open system interconnection (OSI) model. The OSI model defines a conceptual networking framework to implement protocols and divides the task of networking into a vertical stack of the seven layers. In the OSI model, communication control is passed through the layers from the first to the seventh layer. The first or “top” layer is the “physical” layer. Layer 1 transmits the bit stream of ones and zeros indicated by electrical impulse, light, or radio frequency signals—thus providing a method of interacting with actual hardware in a meaningful way. Examples of the physical layer include Ethernet, FDDI, B8ZS, V.35, V.24, and RJ45. The second layer is called the Data Link layer. At layer 2 data packets are encoded and decoded into a bit stream in compliance with transmission protocols that control flow control and frame synchronization. The Data Link layer 2 is actually a combination of two different layers: the Media Access Control (MAC) layer and the Logical Link Control (LLC) layer. The MAC layer controls a computer's access to the network. The LLC basically controls frame synchronization, flow control, and various types of error correction. Examples of the Data Link layer include PPP, FDDI, ATM, IEEE 802.5/802.2, IEEE 802.3/802.2, HDLC, and Frame Relay. The third OSI layer, called the “Network” layer, provides the switching and routing technology to create logical paths to transmit data from one node to another in the network. Layer. The Network layer also performs the function of routing, forwarding, addressing, internetworking, error handling, congestion control, and packet sequencing. Layer 3 examples include AppleTalk, DDP, IP, and IPX. The fourth OSI layer is the Transport layer. Layer 4 provides transparent transfer of data between devices. Layer 4 also performs error recovery and provides flow control for complete data transfer. Examples of layer 4 include SPX, TCP, and UDP. OSI layer 5 called the Session layer because it manages and terminates the connections between different applications. The Session layer coordinates communication between applications. It sets up communications and terminates the communications between applications at each end—establishing and ending a “session.” Examples include NFS, NetBios, names, RPC, and SQL. Layer 6 is called the Presentation Layer. Layer 6 is really the “transformation” layer—transforming data from the final layer to a format the network understands and vice versa. Layer 6 formats and encrypts data sent on the network and decrypts the data from the network. Examples include ASCII, EBCDIC, TIFF, GIF, PICT, JPEG, MPEG, and MIDI. Finally, the last layer 7, is called the Application Layer. Everything at this layer is specific to applications, and this layer provides the services for email, file transfers, and other network applications. Examples include WWW browsers, NFS, SNMP, FTP, Telnet, and HTTP.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), complex instruction set computers (CISCs), reduced instruction set computers (RISCs), advanced RISC machines (ARMs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof. A processor is implemented in logic circuitry that includes the basic functions of AND, NAND, OR, and NOR functions. The circuitry responds to the basic instructions that operate an computing device. In some computing devices the processor is actually referred to a as microprocessor. Functionally, processors are typically composed of RAM as well as address and data buses, the processing circuitry and accumulators. The busses supply the data and programming instructions from RAM, ROM, CACHE, or other memory to the processing circuitry. The speed of a processor depends both on the speed of the processing circuitry as well as the speed of the data and address busses that supply the circuitry. And the speed of the data and address buses are also gated by the speed of the RAM. It is critical that all of these components have speeds that are matched to one another to maximize processor performance. Processors use machine level instruction codes to manipulate data. Other instructions must be compiled to machine level instructions to for the processor to perform the operations. Dual core processors have dual processing circuitry and multiple address and data buses.

Also, it is noted that the embodiments may be described as a process which is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine readable medium such as a storage medium. A code segment or machine-executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read only memory (ROM), random access memory (RAM), magnetic RAM, core memory, magnetic disk storage mediums, optical storage mediums, flash memory devices and/or other machine readable mediums for storing data. The term “machine-readable medium” includes, but is not limited to portable or fixed storage devices, optical storage devices, and/or various other storage mediums capable of storing that contain or carry instruction(s) and/or data. Cache memory, also called the central processing unit (CPU) memory, is random access memory that the processor can access more quickly than standard RAM. Cache memory is typically integrated into the circuitry with the processing unit, but sometimes can be placed on a separate chip. The principle purpose of cache memory is to store the program instruction for the operational software such as an operating systems. Most long running software instructions reside in cache memory if they are accessed often.

While the principles of the disclosure have been described above in connection with specific apparatuses and methods, it is to be clearly understood that this description is made only by way of example and not as limitation on the scope of the disclosure.

What is claimed is:

1. A processor-based method for forecasting onward-travel demand in a transit system, the method comprising:
continuously receiving, over a network and at a transit server, one or more user records from an onward-travel server, wherein each user record of the one or more user records comprises:
a departure time from one of a plurality of departure locations;
an arrival time of one or more arrival times, to one of one or more arrival locations; and
an onward-travel type of one or more onward-travel types; and
processing, by the transit server, the one or more user records, for each arrival location of one or more arrival locations, and for each arrival time of one or more arrival times at each location, and for each onward-travel type of one or more travel types at each location at each arrival time, the processing comprising:
determining an onward-travel count of one or more onward-travel counts for one or more users, wherein the one or more users need an onward-travel type;
generating a request of one or more requests, for an onward-travel count of the onward-travel type; and
transmitting, over the network, the request of the one or more requests to an onward transportation resource.

2. The processor-based method for forecasting onward-travel demand in a transit system of claim 1, wherein the one or more onward-travel types comprise one or more of ride shares, taxis, bicycle hires, pedal-cabs, limousines, buses, shuttles, personal drones, and hover-craft.

3. The processor-based method for forecasting onward-travel demand in a transit system of claim 1, wherein the transit system comprises one or more of trains, light-rail, subway, busses, ferries, and/or airplanes.

4. The processor-based method for forecasting onward-travel demand in a transit system of claim 1, the method further comprising:
reading, by a fare-reader, a fare media at a read time and at a user departure location, wherein the user departure location is a one of the one or more departure locations, wherein the fare media is associated with a user identification of a user;
transmitting, by the fare-reader and over the network, to the onward-travel server:
the user identification;
the read time; and
the user departure location;
determining, by the onward-travel server, the user identification is associated with an onward-travel record in an onward-travel database;
retrieving, by the onward-travel server, the onward-travel record from the onward-travel database;
determining, by the onward-travel server and from the onward-travel record, a user onward-travel type, wherein the user onward-travel type is one of the one or more onward-travel types, and a user arrival location, wherein the user arrival location is a one of the one or more arrival locations;
generating, by the onward-travel server, a user arrival time, wherein the user arrival time is a one or the one or more arrival times, based on:
determining, by the onward-travel server, a next transport departure time at the user departure location;
determining, by the onward-travel server, a next transport arrival time at the user arrival location;
creating, by the onward-travel server, a user record of one or user records comprising:
a user departure time;
the user departure location;
the user arrival location;
the user arrival time; and
the user onward-travel type; and
transmitting, by the onward-travel server, the user record of the one or more user records to the transit server.

5. The processor-based method for forecasting onward-travel demand in a transit system of claim 4, the method further comprising creating the onward-travel record by recording one or more transactions of the user for a same arrival location at a same arrival time and using a same onward-travel type.

6. The processor-based method for forecasting onward-travel demand in a transit system of claim 1, the method further comprising:
reading, by a fare-reader, a fare media at a user departure location and at a read time, wherein the user departure location is a one of the one or more departure locations;
receiving a first input from a user of the one or more users, wherein the first input comprises an user arrival location, wherein the user arrival location is a one of the one or more arrival locations;
receiving a second input from the user of the one or more users, wherein the second input comprises a user onward-travel type, wherein the user onward-travel type is a one of the one or more onward-travel types;
transmitting, over the network and to the onward-travel server, the user departure location, the read time, the user arrival location, and the user onward-travel type;
generating, by the onward-travel server, a user arrival time, wherein the user arrival time is a one of the one or more arrival times, based on:
determining, by the onward-travel server, a next transport departure time at the user departure location;
determining a next transport arrival time at a user arrival location;
creating, by the onward-travel server, a user record of one or more user records comprising:
the user departure location;
the read time
the user arrival time;
the user arrival location; and
the user onward-travel type; and
transmitting, over the network, the user record of the one or more user records to the transit server.

7. The processor-based method for forecasting onward-travel demand in a transit system of claim 6, wherein the first input and the second input is provided in response to a request from a transit input device or from a user device of the user.

8. A non-transitory computer-readable medium having sets of instructions stored thereon for forecasting onward-travel demand in a transit system which, when executed by a computer, cause the computer to perform actions of:
continuously receiving, over a network and at a transit server, one or more user records from an onward-travel server, wherein each user record of the one or more user records comprises:
a departure time from one of a plurality of departure locations;
an arrival time of one or more arrival times, to one of one or more arrival locations; and
an onward-travel type of one or more onward-travel types; and
processing, by the transit server, the one or more user records, for each arrival location of one or more arrival locations, and for each arrival time of one or more arrival times at each location, and for each onward-travel type of one or more travel types at each location at each arrival time, the processing comprising:
determining an onward-travel count of one or more onward-travel counts for one or more users, wherein the one or more users need an onward-travel type;
generating a request of one or more requests, for an onward-travel count of the onward-travel type; and
transmitting, over the network, the request of the one or more requests to an onward transportation resource.

9. The non-transitory computer-readable medium having sets of instructions stored thereon for forecasting onward-travel demand in a transit system of claim 8, wherein the one or more onward-travel types comprise one or more of ride shares, taxis, bicycle hires, pedal-cabs, limousines, buses, shuttles, personal drones, and hover-craft.

10. The non-transitory computer-readable medium having sets of instructions stored thereon for forecasting onward-travel demand in a transit system of claim 8, wherein the transit system comprises one or more of trains, light-rail, subway, busses, ferries, and/or airplanes.

11. The non-transitory computer-readable medium having sets of instructions stored thereon for forecasting onward-travel demand in a transit system of claim 8, further comprising:
reading, by a fare-reader, a fare media at a read time and at a user departure location, wherein the user departure location is a one of the one or more departure locations, wherein the fare media is associated with a user identification of a user;
transmitting, by the fare-reader and over the network, to the onward-travel server:
the user identification;
the read time; and
the user departure location;
determining, by the onward-travel server, the user identification is associated with an onward-travel record in an onward-travel database;
retrieving, by the onward-travel server, the onward-travel record from the onward-travel database;
determining, by the onward-travel server and from the onward-travel record, a user onward-travel type, wherein the user onward-travel type is one of the one or more onward-travel types, and a user arrival location, wherein the user arrival location is a one of the one or more arrival locations;
generating, by the onward-travel server, a user arrival time, wherein the user arrival time is a one or the one or more arrival times, based on:
determining, by the onward-travel server, a next transport departure time at the user departure location;
determining, by the onward-travel server, a next transport arrival time at the user arrival location;
creating, by the onward-travel server, a user record of one or user records comprising:
a user departure time;
the user departure location;
the user arrival location;
the user arrival time; and
the user onward-travel type; and
transmitting, by the onward-travel server, the user record of the one or more user records to the transit server.

12. The non-transitory computer-readable medium having sets of instructions stored thereon for forecasting onward-travel demand in a transit system of claim 11, further comprising creating the onward-travel record by recording one or more transactions of the user for a same arrival location at a same arrival time and using a same onward-travel type.

13. The non-transitory computer-readable medium having sets of instructions stored thereon for forecasting onward-travel demand in a transit system of claim 8, further comprising:
reading, by a fare-reader, a fare media at a user departure location and at a read time, wherein the user departure location is a one of the one or more departure locations;
receiving a first input from a user of the one or more users, wherein the first input comprises an user arrival location, wherein the user arrival location is a one of the one or more arrival locations;
receiving a second input from the user of the one or more users, wherein the second input comprises a user onward-travel type, wherein the user onward-travel type is a one of the one or more onward-travel types;
transmitting, over the network and to the onward-travel server, the user departure location, the read time, the user arrival location, and the user onward-travel type;
generating, by the onward-travel server, a user arrival time, wherein the user arrival time is a one of the one or more arrival times, based on:
determining, by the onward-travel server, a next transport departure time at the user departure location;
determining a next transport arrival time at the user arrival location;
creating, by the onward-travel server, a user record of one or more user records comprising:
the user departure location;
the read time
the user arrival time;
the user arrival location; and
the user onward-travel type; and
transmitting, over the network, the user record of the one or more user records to the transit server.

14. The non-transitory computer-readable medium having sets of instructions stored thereon forecasting onward-travel demand in a transit system of claim 13, wherein the first input and the second input is provided in response to a request from a transit input device or from a user device of the user.

15. A system for forecasting onward-travel demand in a transit system, the system comprising:
one or more processors performing actions of:
continuously receiving, over a network and at a transit server, one or more user records from an onward-travel server, wherein each user record of the one or more user records comprises:
a departure time from one of a plurality of departure locations;
an arrival time of one or more arrival times, to one of one or more arrival locations; and
an onward-travel type of one or more onward-travel types; and
processing, by the transit server, the one or more user records, for each arrival location of one or more arrival locations, and for each arrival time of one or more arrival times at each location, and for each onward-travel type of one or more travel types at each location at each arrival time, the processing comprising:
determining an onward-travel count of one or more onward-travel counts for one or more users, wherein the one or more users need an onward-travel type;
generating a request of one or more requests, for an onward-travel count of the onward-travel type; and
transmitting, over the network, the request of the one or more requests to an onward transportation resource.

16. The system for forecasting onward-travel demand in a transit system of claim 15, wherein the one or more onward-travel types comprise one or more of ride shares, taxis, bicycle hires, pedal-cabs, limousines, buses, shuttles, personal drones, and hover-craft.

17. The system for forecasting onward-travel demand in a transit system of claim 15, wherein the transit system comprises one or more of trains, light-rail, subway, busses, ferries, and/or airplanes.

18. The system for forecasting onward-travel demand in a transit system of claim 15, the system further comprising:
reading, by a fare-reader, a fare media at a read time and at a user departure location, wherein the user departure location is a one of the one or more departure locations, wherein the fare media is associated with a user identification of a user;
transmitting, by the fare-reader and over the network, to the onward-travel server:
the user identification;
the read time; and
the user departure location;
determining, by the onward-travel server, the user identification is associated with an onward-travel record in an onward-travel database;
retrieving, by the onward-travel server, the onward-travel record from the onward-travel database;
determining, by the onward-travel server and from the onward-travel record, a user onward-travel type, wherein the user onward-travel type is one of the one or more onward-travel types, and a user arrival location, wherein the user arrival location is a one of the one or more arrival locations;
generating, by the onward-travel server, a user arrival time, wherein the user arrival time is a one or the one or more arrival times, based on:
determining, by the onward-travel server, a next transport departure time at the user departure location;
determining, by the onward-travel server, a next transport arrival time at the user arrival location;
creating, by the onward-travel server, a user record of one or user records comprising:
a user departure time;
the user departure location;
the user arrival location;
the user arrival time; and
the user onward-travel type; and
transmitting, by the onward-travel server, the user record of the one or more user records to the transit server.

19. The system for forecasting onward-travel demand in a transit system of claim 18, the system further comprising creating the onward-travel record by recording one or more transactions of the user for a same arrival location at a same arrival time and using a same onward-travel type.

20. The system for forecasting onward-travel demand in a transit system of claim 15, the system further comprising:
reading, by a fare-reader, a fare media at a user departure location and at a read time, wherein the user departure location is a one of the one or more departure locations;
receiving a first input from a user of the one or more users, wherein the first input comprises an user arrival location, wherein the user arrival location is a one of the one or more arrival locations;
receiving a second input from the user of the one or more users, wherein the second input comprises a user onward-travel type, wherein the user onward-travel type is a one of the one or more onward-travel types;
transmitting, over the network and to the onward-travel server, the user departure location, the read time, the user arrival location, and the user onward-travel type;
generating, by the onward-travel server, a user arrival time, wherein the user arrival time is a one of the one or more arrival times, based on:
determining, by the onward-travel server, a next transport departure time at the user departure location;
determining a next transport arrival time at the user arrival location;
creating, by the onward-travel server, a user record of one or more user records comprising:
the user departure location;
the read time the user arrival time;
the user arrival location; and
the user onward-travel type; and
transmitting, over the network, the user record of the one or more user records to the transit server.
